(19) United States
(12) Patent Application Publication
(10) Pub. No.: US 2025/0028309 A1
(43) Pub. Date: Jan. 23, 2025

(54) COMPUTER-IMPLEMENTED METHOD FOR CONTROLLING A SYSTEM BASED ON A DETECTED TREND

(71) Applicant: Robert Bosch GmbH, Stuttgart (DE)

(72) Inventor: Xiahan Shi, Renningen (DE)

(21) Appl. No.: 18/771,891

(22) Filed: Jul. 12, 2024

(30) Foreign Application Priority Data
Jul. 18, 2023 (DE) 10 2023 206 823.0

(51) Int. Cl. G05B 23/02; G07C 5/00

(52) U.S. Cl. CPC G05B 23/0221; G07C 5/006

(57) ABSTRACT

A computer-implemented method for controlling a system based on a trend detected in a data time series acquired by a sensor. The method includes: acquiring and providing a data time series by a sensor; applying at least one linear filter function with a resolution L to each point in time of the data time series and obtaining a characteristic value for quantifying the temporal development of the data time series for each resolution L; detecting a trend in the data time series when one of the characteristic values of the data time series reaches a threshold value; and triggering a response of the system when a trend has been detected in the data time series.

### FIELD

The present invention relates to the field of automated trend recognition in data and to controlling a system based on a recognized trend.

### BACKGROUND INFORMATION

Trend recognition in system workflows can be critical for detecting, for example, wear and tear, unusual behavior, or maintenance needs of a system. The earlier a trend is detected, especially one that is harmful to the system, the better it can be counteracted, or measures can be taken to eliminate the trend. This makes it all the more important to automatically read such a trend from data that are available early on. For this purpose, there are various approaches for automatically detecting trends in data time series.

An estimation for linear trends is described in Bianchi et al., “A comparison of methods for trend estimation,” Applied Economics Letters 6.2 (1999): 103-109. The method described there uses statistics to decompose a data time series into a trend, seasonality, and noise. In this approach, there are two types of trend detection, namely model-based and non-parametric trend detection. In non-parametric trend detection, for example, a convolution is applied between a triangular filter and a finite, symmetric window of the data time series.

Percival et al, “Wavelet methods for time series analysis,” vol. 4., Cambridge University Press, 2000, describes a wavelet analysis that can be compared with a Fourier analysis. Instead of the sine and cosine functions, however, wavelets are used here that represent a local oscillation around 0. The signal and the wavelets are then convolved with each other at different resolutions.

Prewitt, Judith M S., “Object enhancement and extraction,” Picture processing and Psychopictorics 10.1, 1970:15-19, describes a filter for finding edges in image processing. A so-called Prewitt operator consists of two 3×3 kernels that are convolved with a grayscale image.

Other approaches use deep learning. However, deep learning has the disadvantage that it requires a relatively large amount of resources for its application. The computing operations are complex, which not only increases the power consumption of the executing system, but also occupies computing capacity that could be used elsewhere, or requires a generally larger system.

An object of the present invention is to provide a resource-saving method for trend detection and the associated control for a system.

This object may be achieved by features of the present invention.

### SUMMARY

According to a first aspect of the present invention, the object is achieved by a computer-implemented method for controlling a system based on a trend that was detected in a data time series acquired by a sensor. According to an example embodiment of the present invention, the method comprises the following steps:
acquiring and providing a data time series by a sensor,
applying at least one linear filter function with a resolution L to each point in time of the data time series and obtaining a characteristic value for quantifying the temporal development of the data time series for each resolution L,
detecting a trend in the data time series when one of the characteristic values of the data time series reaches a threshold value; and
triggering a response of the system when a trend has been detected in the data time series.

The recorded data time series is a time series of in particular one-dimensional data, for example a temperature curve, a fill level curve, a pressure curve or a similar quantity. In other words, the data time series contains a value of a measurable quantity recorded at specific time intervals.

The quantity is recorded by a sensor in the work operations of which a trend is to be recognized. The sensor can therefore be a commercially available sensor for detecting a measured quantity, such as (but not limited to) a thermometer, a pressure sensor, a fill sensor, or electronic measuring devices such as a current meter, a voltmeter, or a resistance meter. The sensor can be part of the system or can monitor a parameter outside the system.

According to an example embodiment of the present invention, a linear filter function is applied to the data time series for each point in time. In particular, applying a filter function to the data time series includes a mathematical operation on the data time series. Applying the filter creates a new function that can be analyzed. Such an analysis makes it possible to quantify the application of the filter to the data time series. In particular, the averaged slope of the new function can provide an indication of the existence of a trend. As a result, from the new function a single characteristic value is ascertained for each resolution, which is suitable for quantifying the temporal development of the data time series.

The characteristic value can then preferably be compared with a threshold value. The threshold value can preferably be selected such that a small trend in the data time series is not recognized as a trend within the meaning of the present invention. This can prevent a minor trend, for example one that lies within the tolerance range of the system, from triggering the intended action. In other words, the threshold value can be chosen to take into account the usual measurement errors of the sensor, the play of any moving parts in the system, or, in general, tolerances of the system.

If the characteristic value exceeds the threshold, this inevitably leads to a response of the system being triggered. Since the threshold value already takes into account the error range in the acquisition of the data time series and the regular work of the system, there is an actual trend in the data time series that requires a response of the system. For example, a temperature can slowly rise or fall beyond a certain fluctuation, allowing the system to respond accordingly, for example with more or less input power.

If the error range is known based on physical system knowledge, a fixed threshold value can in particular be used. If a value is in an anomalous range outside the usual or expected operating range, the threshold value can be determined statistically from past observations if necessary. Alternatively, the threshold can also be calibrated on a validation data set so that the known anomalies are reliably detected with the lowest possible false positive rate.

The response of the system can depend on the system itself and/or the monitored data time series. A trend does not always have to have negative effects on a system. Positive effects are also possible. For example, when a new machine is put into operation and a data time series records a vibration of the machine, the vibrations may decrease over time until the machine has run in and, for example, the lubricant is sufficiently distributed in its parts for normal operation.

Since the application of a linear filter function to a data time series places only very low demands on the resources of the system, the method according to the present invention is suitable, independently of the system, for detecting a trend in a data time series that triggers a response of the system in a resource-saving manner.

In one example embodiment of the present invention, the trend to be detected is an upward trend or a downward trend.

Depending on whether an upward or downward trend is to be detected, the filter can be implemented with a different sign. This makes the implementation of a corresponding filter particularly easy.

The detection of a trend depends on the direction. The direction of the expected trend in turn depends on the monitored system and the measured parameter. For example, if the condition of a battery cell is monitored, a plurality of parameters may in principle be suitable to quantify this condition. The temperature or the output power are such parameters. With increasing age, for example, the temperature when power is output can increase. This means that as the battery operates, an upward trend in temperature becomes noticeable over time. Conversely, the performance of a battery can decline as it ages. If the performance is observed over a long period of time, a downward trend in the performance of the battery can be observed. In this particular case, however, the charge cycles of the battery would have to be taken into account, because a full battery usually has a higher power output than a half-empty battery.

To do this, the quantification of the data time series is compared with a threshold value, so that fluctuations on a smaller time scale are taken less into account.

In one example embodiment of the present invention, applying the filter function for a resolution L comprises the following steps:
setting the resolution L;
creating a linear function phi_{L}(t) with L values;
ascertaining a portion of the data time series for a range t-L to t with L values;
multiplying the linear function phi_{L}(t) by the portion of the data time series;
summing all products from the linear function phi_{L} with the data time series for all L values.

A data time series is divided into portions, each containing L portions, for multiplication with the filter function. Each portion f(t) therefore has L values from f(t−L+0) to f(t−L+L)=f(t).

The resolution L determines how many values of the data time series are examined for a trend. Depending on the system and the monitored process, the resolution L can be selected differently.

The sensors used and the data time series examined can also influence the resolution. For example, if a measured value is recorded once a day and the data time series is made up of values for a period of weeks, months, or even years, a different, in particular low resolution may be suitable. However, if the vibrations in a motor of a system are monitored at the millisecond or even microsecond level, the portion of the data time series examined can include a number of values that is many times larger. The resolution should therefore be higher so that more values are taken into account when searching for a trend.

In particular, the linear filter is designed in such a way that it increases or decreases in L steps from −1 to +1, depending on whether the trend to be detected is upward or downward. The resulting linear function phi_{L}(t) is multiplied by the portion of the data time series f(t) and the resulting products are summed:

$$k = {\sum }_{l} p h {i}_{L} ( l ) * f ( l )$$

with l from 0 to L.

The characteristic value can be detected in particular as a magnitude in order to also identify a downward trend. In this case the characteristic value would be K=|k|. On the other hand, a negative product k can also indicate a negative trend. Therefore, the characteristic value is evaluated not only according to its magnitude, but also according to its sign. If K falls below or exceeds the threshold value S, a trend is detected.

In one example embodiment of the present invention, the individual products phi_{L}(l)*f(l) are weighted differently when summed. For this purpose, the characteristic value K can be calculated, for example, using a modified formula:

$$K = \vert k \vert = {Σ}_{l} w ( l ) * p h {i}_{L} ( l ) * f ( l ) .$$

The weighting factor w(l) can be weighted more heavily in particular for the edge regions of the data time series under consideration. For example, but not limited thereto, this would be:

$$w ( l ) = \frac{1}{2} cos 2 π l .$$

Weighting certain regions of the data time series to detect a trend has the advantage that linear trends can be detected more easily. In particular, if the edge regions of the data time series examined are monitored, finding a trend can be made easier because precisely these areas would be particularly far apart if a trend actually existed.

In one example embodiment of the present invention, the system is a test bench for a motor vehicle and the system's response to detecting a trend includes shutting off the test bench. In particular, the data time series can be a parameter to be examined of the vehicle tested on the test bench. These include, for example, but are not limited to, exhaust gas values or the temperature of the exhaust gases as well as the temperature or performance of a battery of an electric vehicle.

If a trend is detected, it may indicate a malfunction or a need for maintenance of the vehicle. The test bench itself is then no longer needed, as the question of the need for maintenance has then been clarified. Switching off the system therefore saves energy and resources, as another vehicle can be brought to the test bench if necessary, while the one currently being tested is taken to a workshop. Furthermore, the vehicle being tested can also be switched off, so that fewer exhaust gases are produced or the battery is not placed under unnecessary strain.

In a further example embodiment of the present invention, the sensor is a sensor for measuring temperature. In this embodiment, the data time series can be the temperature of a subsystem of the motor vehicle, in particular a battery, a fuel cell or a drive unit.

A temperature that is too high in a vehicle subsystem usually means that there is a risk of damage to the vehicle. If the battery gets too warm, the individual battery cells could age faster. If the exhaust gases are too warm, this indicates faulty fuel combustion.

In another example embodiment of the present invention, the system is a vehicle and the sensor detects a parameter of the vehicle or of a subsystem thereof.

Advantageously, the method of the present invention is particularly suitable for being executed by an onboard computer of the vehicle, because onboard computers are often equipped with very limited resources. The resource-saving detection according to the present invention of trends in data time series is therefore particularly suitable for onboard applications of a vehicle.

In one example embodiment of the present invention, the system is a moving part in a machine. The sensor can then in particular be a sensor for detecting the vibration of the part of the machine, wherein the response of the system comprises switching off the machine or labeling the machine as requiring maintenance.

Almost every machine inevitably requires maintenance. However, it is often difficult to estimate the true level of wear and tear, which leads to maintenance being carried out that is not yet necessary. Maintenance costs the operator of a machine money and time, so maintenance is postponed whenever possible. Indicators that indicate the need for maintenance enable maintenance to be carried out at the most efficient time.

Machines with moving parts usually vibrate. The vibrations can be like a fingerprint of the machine's working process. If wear sets in, more friction can occur in moving parts, for example because there is a lack of lubricating fluid, lubricating plates are worn out, or the play between two parts has increased. These effects cause the vibrations in the machine to become stronger.

If the amplitude of the vibration of a machine is recorded as a data time series, the method according to the present invention can be used to examine this data time series for a trend. An upward trend in the data time series is then synonymous with stronger vibrations and thus with greater wear. The threshold value can be used to set the moment from which wear is no longer tolerable, which triggers a response from the system. In some cases the machine may then be switched off for safety reasons. In other cases, labeling the machine is sufficient. In particular, the machine can be labeled as “requiring maintenance” to signal to the operator that the machine in fact needs to be serviced. This embodiment makes it possible to schedule maintenance at a necessary time in the operation of the machine. This means that no costs have to be incurred for maintenance that is not yet necessary, which makes the machine more cost-effective to operate.

In another case, the machine can be labeled as “ready for operation.” When a new or recently serviced machine is put into operation, it may be that operational readiness first has to be established. For example, a lubricant must first be distributed in moving parts or certain components must reach a target temperature. For example, a sensor can record the vibrations of the machine as a data time series. If the amplitude of the vibrations decreases over time, this can be recognized as a trend as long as the characteristic value for the vibration time series is above a corresponding threshold. This downward trend can, for example, cause the machine to be labeled as “warming up,” “in preparation,” etc. However, if the characteristic value reaches a level below the threshold, the label expires and the machine is indirectly or directly marked as “ready for operation.” The indirect labeling as “ready for operation” may in particular include the omission of the labeling “not ready for operation” or a comparable labeling.

In a further example embodiment of the present invention, the system is a fuel cell. The sensor measures the pressure in the fuel cell, the current supplied by the fuel cell, the temperature on or in the fuel cell, or generally a virtually ascertained operating state of the fuel cell. In this embodiment, the response of the system may in particular include reducing the power of the fuel cell or switching off the fuel cell.

Fuel cells are based on the principle of electrochemical reaction between a fuel and an oxidizing agent, which produces electrical energy. They consist of several main components, including an anode, a cathode and an electrolyte. The anode serves as the site for the oxidation of the fuel, while the cathode is responsible for the reduction of the oxidizing agent. The electrolyte enables the transport of ions between the anode and the cathode. The electrolyte layer between the anode and the cathode allows the flow of ions, thereby generating the electrical current.

To ensure efficient and long-term performance of the fuel cell, the selection of suitable catalysts is of great importance. The catalysts should have a high activity in order to accelerate the reactions at the anode and cathode. In addition, they should be stable and have good resistance to the operating conditions of the fuel cell, including temperature, pressure and fuel composition.

Each of the parameters mentioned can be recorded as a data time series by a corresponding sensor. If a trend is detected in one of these data time series, this may indicate abnormal, possibly inefficient operation of the fuel cell.

By switching off or reducing the power of the fuel cell, the fuel cell can be protected from damage or at least preserved before damage can take effect. Furthermore, the fuel cell can be labeled, in particular as “requiring maintenance.”

In a further aspect, the present invention relates to a computer program with program code for carrying out a method according to the present invention for controlling a system based on a trend detected in a data time series acquired by a sensor as described above when the computer program is executed on a computer.

In a further aspect, the present invention relates to a computer-readable data carrier with program code of a computer program for carrying out a method according to the present invention for controlling a system based on a trend detected in a data time series acquired by a sensor as described above when the computer program is executed on a computer.

In a further aspect, the present invention relates to a subsystem for a system for carrying out a method of the present invention for controlling the system based on a trend detected in a data time series acquired by a sensor, wherein the subsystem comprises means for carrying out the method for controlling the system based on the detected trend as described above.

The subsystem can in particular be implemented as part of a system. For example, the subsystem can be designed as part of a fuel cell that monitors the acquired data time series.

Overall, a computer-implemented method for controlling a system based on a trend detected in a data time series acquired by a sensor and a device for carrying out this method are thus provided.

The described embodiments and developments of the present invention can be combined with one another as desired.

Further possible embodiments, developments, and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of the example embodiments of the present invention. They illustrate example embodiments of the present invention and, in connection with the description, serve to explain principles and concepts of the present invention.

Other embodiments and many of the mentioned advantages are apparent from the figures. The illustrated elements of the figures are not necessarily shown to scale relative to one another.

FIG. 1 schematically shows the sequence of a method according to one example embodiment of the present invention.

FIG. 2 schematically shows the sequence of part of the method according to one example embodiment of the present invention.

FIGS. 3A and 3B show two exemplary data time series with linear filters and the product thereof in tabular form, according to the present invention.

FIG. 4 shows a data time series represented as a graph in which one or more trends have been recognized.

FIG. 5 shows a subsystem for carrying out the method according to one example embodiment of the present invention.

### DETAILED DESCRIPTION OF EXAMPLE EMBODIMENTS

In the figures of the figures, identical reference signs denote identical or functionally identical elements, parts or components, unless stated otherwise.

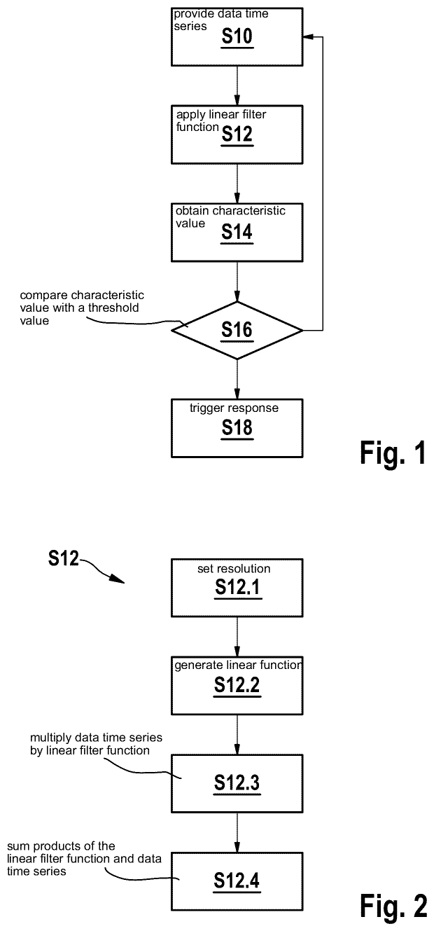

FIG. 1 schematically shows the sequence of a method according to one embodiment of the present invention. The method begins by providing a data time series acquired by a sensor in step S10.

In one embodiment, the data time series represents the temporal curve of a parameter that characterizes the system controlled within the scope of the method. The sensor can preferably be part of the system and forward the data time series to a subsystem of the system thus monitored. This makes it possible to examine the data time series for a trend while the system is running.

In embodiments, it is possible for the sensor to capture a parameter of a system as a data time series that is different from the system in which a response is triggered. For example, the sensor can detect a parameter of a vehicle, in particular a battery status, and forward it to a test bench. A response is then triggered on the test bench when a trend is detected in the data time series of the vehicle parameter.

To execute the method, the data time series can be buffered. Preferably, the system has a dedicated working memory or an area in its working memory for this purpose. The size of the working memory or the available working memory determines the number of data points in the data time series that can be used for trend detection.

In step S12, a linear filter function is applied to the acquired data time series for at least one resolution L. Applying the filter function to the data time series creates a new function that is quantifiable. From this new function, a characteristic value can therefore be obtained in step S14, by means of which an upward trend or a downward trend can be identified. The characteristic value can in particular be the slope of a regression line through the new function.

In step S16, the characteristic value of the data time series is compared with a threshold value and is checked as to whether it reaches this threshold value or not. Depending on the system being monitored, the data time series being recorded and the expected trend, the threshold value can not be met or can be exceeded as required. If the aim is to prevent a parameter from increasing too much, for example the amplitude of the vibration detected by a motion sensor, then a trend is detected when the parameter exceeds the threshold. However, if, for example, the performance of the system is measured and the system is monitored to ensure that the performance does not fall below a certain value, then a downward trend will be detected when the parameter does not meet the threshold.

If the characteristic value reaches the threshold value, a response of the system to the detection of a trend in the data time series is triggered in step S18. The response triggered depends on the system and the monitored parameter. The response may include labeling the system with a specific operating state, in particular “needs maintenance,” or shutting off the system. In embodiments, specific processes can also be triggered when a trend is detected. For example, an additional drain valve of an intermediate storage tank for liquids can be opened if the fill level shows an increasing trend.

If no trend is detected when comparing the characteristic value with the threshold value, the method continues with step S10 and the process starts again.

In embodiments, a second run of the method may be performed with a second data time series, wherein a portion of the values match the values of the first data time series from the first run. In this way, for example, a parameter can be continuously monitored and examined for trends. For example, the method can be carried out with a data time series that comprises 100 values. During the first run, the first 100 values are examined for a trend. In a second run, 50 new values are acquired, so that the 100 values of the data time series for the second run consist of 50 values of the first data time series from the first run and 50 newly acquired values. This allows trends to be detected with twice the temporal resolution.

FIG. 2 schematically shows substeps of step S12 of FIG. 1, the application of the filter function, according to one embodiment. In a first substep S12.1, a resolution is set for the data time series to be examined. The setting can be carried out individually, i.e. adapted to the situation of the monitored system and/or external circumstances. In particular, one or more resolutions can be predefined. Alternatively, the resolution can be set systematically and identically for each run.

Next, a linear function phi_{L}(t) is generated (S12.2), which forms a linear filter. The function phi_{L}(t) contains as many values as the data time series or the portion of the data time series in which a trend is to be detected. The number of values corresponds to the resolution L.

A data time series is fundamentally not limited to a specific number of values. Within the scope of the present invention, a data time series is formed from a defined number L of values from a data time series that can be acquired without limit. This makes it possible to examine a continuously recorded data time series for trends at regular intervals. For this purpose, the values of the data time series can be continuously written to a buffer, wherein the oldest values of the data time series are overwritten with the most recent values. Every time a trend is to be detected in the data time series, the buffer is read. The data time series of length L thus acquired is multiplied by the linear filter function phi_{L}(t) in step S12.3.

In the last step S12.4 shown in FIG. 2, the products of the linear filter function phi_{L}(t) and the data time series f(t) are summed. This results in a single value that can be used as a characteristic value in the further method sequence (see FIG. 1).

If the linear function phi_{L}(t) with L values is such that it increases linearly from −1 to +1, the characteristic value would be 0 or close to 0 if no trend is discernible in the data series, since the individual products should cancel each other out. However, if a trend exists, the characteristic value would be significantly larger or smaller than 0, because later values in the data series would then have a greater influence on the characteristic value than earlier values.

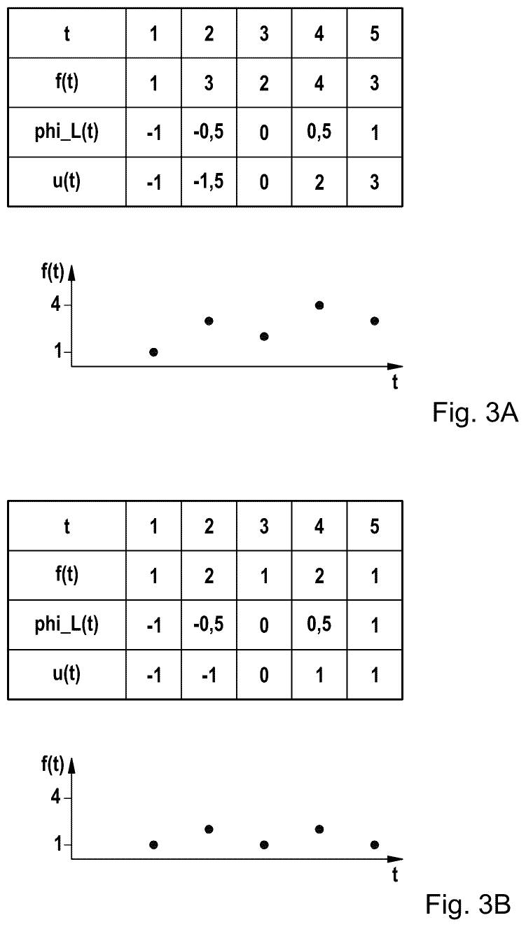

FIG. 3A and 3B show two data time series f(t), in table form, that are multiplied by a linear filter function phi_{L}(t) to form a new function u(t). The values of the new function u(t) can be summed to form a characteristic value for the data time series f(t).

A slight upward trend can be seen in the data time series f(t) shown in FIG. 3A. This is particularly evident from the graphical representation of the data time series f(t). The data time series f(t) in FIG. 3B fluctuates back and forth between the values 1 and 2 and thus shows no trend downward or upward.

Since the data time series f(t) in this example consists of five values, the linear filter function phi_{L}(t) is also divided into five steps. The filter function phi_{L}(t) runs linearly from −1 to +1 in steps of 0.5.

If the data time series f(t) is multiplied entry by entry by the filter function phi_{L}(t), the new function u(t) is obtained. The function u(t) is therefore calculated with

u(t)=f(t)*phi_{L}(t)

The characteristic value k of the data time series f(t) is then formed as the sum of the values of the function u(t).

$$k = {Σ}_{t} u ( t ) = {Σ}_{t} f ( t ) * p h {i}_{L} ( t ) .$$

The characteristic value k for the data time series f(t) from FIG. 3A is therefore 2.5 (=−1+−1.5++0+2+3). The characteristic value for the data time series f(t) from FIG. 3B, however, is 0 (=−1+−1+0+1+1).

The characteristic value is compared with a threshold value. For example, this threshold value could be 1. All values k above 1 or below −1 would then represent a trend in a data time series f(t). Positive characteristic values would also indicate an upward trend and negative values would indicate a downward trend.

However, it is important to note that the examples for the data time series f(t) shown in FIGS. 3A and 3B are greatly simplified and are intended only to illustrate the principle of the present invention. In order to be able to make a statistically relevant statement about a trend, it is advantageous to use a data time series with as many values as possible.

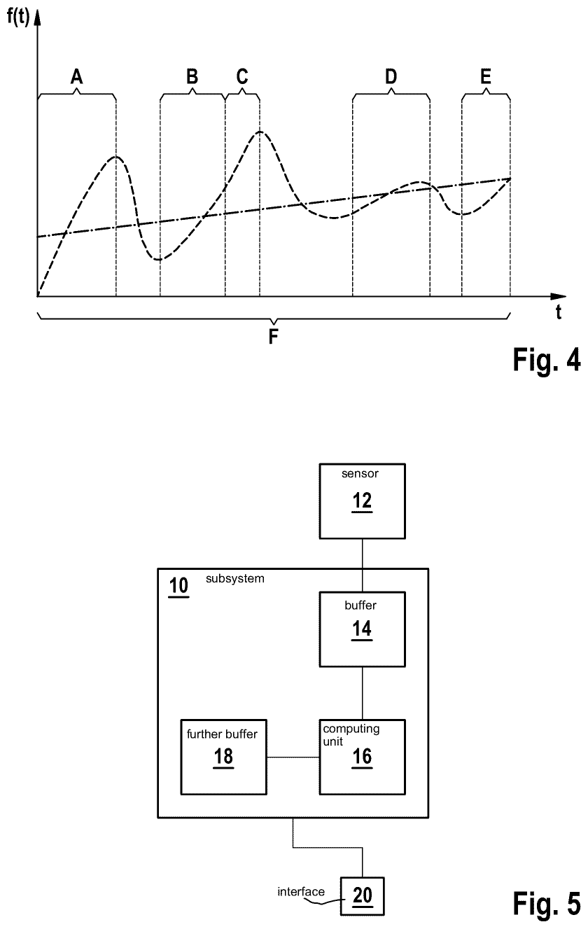

FIG. 4 shows another data time series f(t) over time t. The data time series itself is shown as a dotted line. The data time series may have been acquired while analyzing or monitoring a system and may include one or more processes.

In this example, the data time series f(t) was examined for upward trends. Upward trends were detected in portions A, B, C, D, and E. It should also be noted that the upward trend in portion C is steeper than the upward trend in portion B. This can be recognized, for example, by the fact that the characteristic value for portion C is higher than the characteristic value for portion B.

Between portions A and B, C and D, and D and E, the data time series f(t) decreases. In principle, downward trends could be detected here, but in this embodiment they are irrelevant due to a selection based on positive characteristic values above the threshold value.

In addition to the upward trends in portions A to E, however, a longer-term upward trend can also be detected over the entire data time series f(t), summarized as portion F. A straight line reflecting this trend is also shown in the graph as a dot-dash line. This is intended to illustrate that the data time series f(t) does not have to be examined for trends on only one time scale. It can be monitored on different time scales to detect micro or macro trends. For this purpose, the individual values of the data time series can be stored in a buffer over a longer period of time. If micro trends are of interest, a portion of the data series can be examined for trends. If, on the other hand, a macro trend is to be detected, a longer period of time is examined for trends, and accordingly more values are read from the system.

FIG. 5 shows, schematically and by way of example, an embodiment of a subsystem 10 for controlling a system based on a trend that was detected in a data time series acquired by a sensor 12.

The subsystem 10 is configured to receive and process a data time series from the sensor 12. For this purpose, the subsystem 10 is communicatively connected to the sensor 12. The communicative connection can be wired or wireless. In particular, the sensor 12, or another subsystem hosting the sensor 12, sends the data time series as a continuous data stream, or in packets comprising a plurality of values, to a buffer 14 of the subsystem 10. The values of the data time series are temporarily stored in the buffer 14 until they are read out and further processed. The buffering can continue until, for example, sufficient data are available to carry out trend detection.

A computing unit 16 can read the data time series from the buffer 14 as a whole or in part in order to detect a trend in the data time series or a part thereof according to the present invention. The computing unit 16 can for example comprise a CPU, a GPU or any unit designed to perform the computing operations.

The results of the examination, i.e. information about whether a trend was detected or not, and if so, which trend was detected and when, can be stored in a further buffer 18 by the computing unit 16. In embodiments, the buffer 18 can be part of the buffer 14. Both buffers 14 and 18 can be designed as virtual buffers of the subsystem 10, located on a common hardware module or located separately in different hardware modules.

When the computing unit 16 has detected a trend, the subsystem 10 sends a signal via an interface 20 to a system, which can then respond to the detected trend in a manner corresponding to the signal. The interface 20 can be, for example, a USB or wireless interface, in particular a Bluetooth or WLAN interface. The signal can for example contain concrete instructions for the system to take action, or can activate instructions stored in the system, so that the system itself decides which response is triggered by the information about the detected trend. The latter case is particularly advantageous because the subsystem can then be combined with any systems as an autonomous subsystem, provided that a suitable interface for the interface 20 is available in the system.

1-10 (canceled)

11. A computer-implemented method for controlling a system based on a trend that was detected in a data time series acquired by a sensor, the method comprising the following steps:
acquiring and providing a data time series by a sensor;
applying at least one linear filter function with a resolution L to each point in time t of the data time series and obtaining a characteristic value for quantifying the temporal development of the data time series for each resolution L;
detecting a trend in the data time series when one of the characteristic values of the data time series reaches a threshold value; and
triggering a response of the system when the trend has been detected in the data time series.

12. The computer-implemented method according to claim 11, wherein the trend is an upward trend or a downward trend.

13. The computer-implemented method according to claim 11, wherein the application of the linear filter function for the resolution L includes the following steps:
setting the resolution L;
creating the linear function phi_{L}(t) with L values;
ascertaining a portion of the data time series for a range t-L to t with L values;
multiplying the linear function phi_{L}(t) by the portion of the data time series; and
summing all products from the linear function phi_{L}(t) with the data time series for all L values.

14. The computer-implemented method according to claim 11, wherein the system is a test bench for a motor vehicle and a response of the system includes switching off the test bench and/or the motor vehicle.

15. The computer-implemented method according to claim 14, wherein the sensor is a sensor for measuring temperature and wherein the data time series determines a temperature of a subsystem of the motor vehicle.

16. The computer-implemented method according to claim 11, wherein:
the system is a moving part in a machine,
the sensor is a sensor for detecting vibration of the part, and
the response of the system includes switching off the machine or labeling the machine as requiring maintenance.

17. The computer-implemented method according to claim 11, wherein:
the system is a fuel cell,
the sensor is a sensor for detecting the pressure in the fuel cell, or a sensor for detecting the current supplied by the fuel cell, or a temperature sensor on the fuel cell, or a virtual sensor for detecting an operating state of the fuel cell, and
the response of the system comprises reducing the power of the fuel cell or shutting off the fuel cell.

18. A non-transitory computer-readable medium on which is stored program code of a computer program for controlling a system based on a trend that was detected in a data time series acquired by a sensor, the program code, when executed by a computer, causing the computer to perform the following steps:
acquiring and providing a data time series by a sensor;
applying at least one linear filter function with a resolution L to each point in time t of the data time series and obtaining a characteristic value for quantifying the temporal development of the data time series for each resolution L;
detecting a trend in the data time series when one of the characteristic values of the data time series reaches a threshold value; and
triggering a response of the system when the trend has been detected in the data time series.

19. A subsystem for a system configured to control the system based on a trend that was detected in a data time series acquired by a sensor, the subsystem configured to:
acquire and provide a data time series by a sensor;
apply at least one linear filter function with a resolution L to each point in time t of the data time series and obtaining a characteristic value for quantifying the temporal development of the data time series for each resolution L;
detect a trend in the data time series when one of the characteristic values of the data time series reaches a threshold value; and
trigger a response of the system when the trend has been detected in the data time series.
